(19) United States
(12) Patent Application Publication
(10) Pub. No.: US 2007/0038313 A1
(43) Pub. Date: Feb. 15, 2007

(54) Systems and methods for modifying multi-function device settings

(75) Inventors: Amanda Kay Bridges, Winchester, KY (US); William James Gardner Flowers, Lexington, KY (US); Charles Edward Grieshaber, Versailles, KY (US); Chad Eugene McQuillen, Lexington, KY (US); Michael Ray Timperman, Versailles, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/201,054

(22) Filed: Aug. 10, 2005

(51) Int. Cl. G05B 11/01

(52) U.S. Cl. 700/17; 700/83

(57) ABSTRACT

A method for automatically implementing multi-function device settings includes storing at least one workflow object, where the at least one workflow object is associated with at least one function of a multi-function device, and at least one device setting. After a request to execute the at least one workflow object is received at the multi-function device, the at least one workflow object is executed using the at least one device setting, even if the at least one device setting is different than a default device setting.

### FIELD OF THE INVENTION

The present invention relates generally to multi-function devices, and more particularly, to systems and methods that permit the automatic changing of multi-function device settings.

### BACKGROUND OF THE INVENTION

Conventional multi-function devices providing scan, copy, print, and fax features permit a user to change a multitude of device settings, including, for instance, paper size, paper source, darkness, orientation, number of copies, and the like. These devices also include additional options related to the transmission of digital versions of a document, such as a fax number, output format, email address destination, and the like. Many of these settings are default settings that may be changed by a user.

Unfortunately, however, current multi-function devices only permit a user to vary some of these settings during the request for a function, such as during the request for the scan of a document and its transmission to an email address. These devices do not permit the changing of settings automatically based on the identity of a user or based upon executing a particular job, such as a fax job. Thus, a user typically has to re-enter one or more settings to execute a job in the format the user desires.

Therefore, what is needed is are multi-function devices that automatically establish device settings based on the type of job or function executed by the device, or the identity of a user.

### BRIEF SUMMARY OF THE INVENTION

Systems, methods and apparatuses of the present invention enable the automatic alteration of device settings based on the identity of a user or based on a job type. After authenticating a user, the multifunction device will present a user with objects, such as print jobs, associated with the user. These objects may each be associated with device settings such that the user does not have to alter the device settings each time the user wishes to utilize the object. For instance, an object may be a fax job, such that each time a user wishes to execute the fax job it is the faxed according to the stored device settings, which may include, for instance, a fax telephone number, or the like.

To effect the execution of jobs using stored device settings the multi-function device applies device settings to users and/or functions, where the device settings are accessed and implemented upon the execution of an object. These settings may be stored local to the multi-function device, or external to the device, such as on a remote server.

According to an embodiment of the invention, there is disclosed a method for implementing multi-function device settings. The method includes storing at least one workflow object, where the at least one workflow object is associated with at least one function of a multi-function device and at least one device setting. The method further includes receiving, at the multi-function device, a request to execute the at least one workflow object, and executing the at least one workflow object using the at least one device setting.

According to one aspect of the invention, the method further includes storing a plurality of default device settings, where the at least one device setting is different than each of the plurality of default device settings. According to another aspect of the invention, the at least one device setting comprises a value pair. The value pair may include a name string and a setting value, or a shortcut key and a setting value.

According to yet another aspect of the invention, the at least one device setting may be defined by a universal configuration file, and/or may be associated with a user. The at least one device setting may further be created by a user and associated with a plurality of workflow objects.

According to another embodiment of the invention, there is disclosed a method of changing multi-function device settings. The method includes receiving a request, from a user, to execute at least one job, and identifying that the at least one job is associated with the at least one device setting, where the at least one device setting is stored in a configuration file. The method further includes automatically changing the settings of a multi-function device to the at least one device setting, and executing the at least one job using the at least one device setting.

According to one aspect of the invention, the method further comprises storing the at least one device setting in a configuration file. According to another aspect of the invention, receiving a request to execute at least one job includes receiving a shortcut name from the user, where the shortcut name identifies the at least one job. According to yet another aspect of the invention, the at least one device setting is selected from the group of settings consisting of an email destination, a fax destination, and an ftp destination. Additionally, the at least one device setting may include a value pair, which may include a name string and a setting value, and/or a shortcut key and a setting value.

According to yet another embodiment of the invention, there is disclosed a device operable to print a document. The device includes at least one interface, where the at least one interface is operable to receive a configuration file associated with a workflow object. The device also includes an object store operable to receive the configuration file, and in response, operable to use the configuration file to identify one or more device settings, and to automatically alter the settings of the device for executing the workflow object.

According to an aspect of the invention, the configuration file is automatically generated by the device in response to a user previously altering the one or more device settings. According to another aspect of the invention, the configuration file comprises a value pair, which may include a name string and a setting value, and/or a shortcut key and a setting value.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of a Multi-function product (MFP), according to an embodiment of the present invention.

FIG. 2 shows containers, workflow objects, sub-containers, and their respective contents, according to an illustrative example of the present invention.

FIG. 3 shows a held jobs container, according to an illustrative embodiment of the present invention.

FIG. 4 shows a user container within the held jobs container of FIG. 2, according to an illustrative embodiment of the present invention.

FIG. 5 shows a home screen GUI, according to an illustrative embodiment of the present invention.

FIG. 6 shows a held jobs GUI, according to an illustrative embodiment of the present invention.

FIG. 7 shows a search GUI, according to an illustrative embodiment of the present invention.

FIG. 8 shows a search results GUI, according to an illustrative embodiment of the present invention.

FIG. 9 shows a PIN GUI, according to an illustrative embodiment of the present invention.

FIG. 10 shows a bookmark GUI, according to an illustrative embodiment of the present invention.

FIG. 11 shows a print/delete GUI, according to an illustrative embodiment of the present invention.

FIG. 12 shows a user-container GUI, according to an illustrative embodiment of the present invention.

FIG. 13 shows a print all GUI, according to an illustrative embodiment of the present invention.

FIG. 14 shows a user-specific confidential jobs GUI, according to an illustrative embodiment of the present invention.

FIG. 15 shows a workflow object print GUI, according to an illustrative embodiment of the present invention.

FIG. 16 shows a USB Drive GUI, according to an illustrative embodiment of the present invention.

FIG. 17 shows a USB drive subdirectory GUI, according to an illustrative embodiment of the present invention.

FIG. 18 shows a file deletion GUI, according to an illustrative embodiment of the present invention.

FIG. 19A shows an illustrative configuration file, according to an embodiment of the present invention.

FIG. 19B shows an illustrative configuration file, according to another embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### I. Illustrative Multi-Function Module

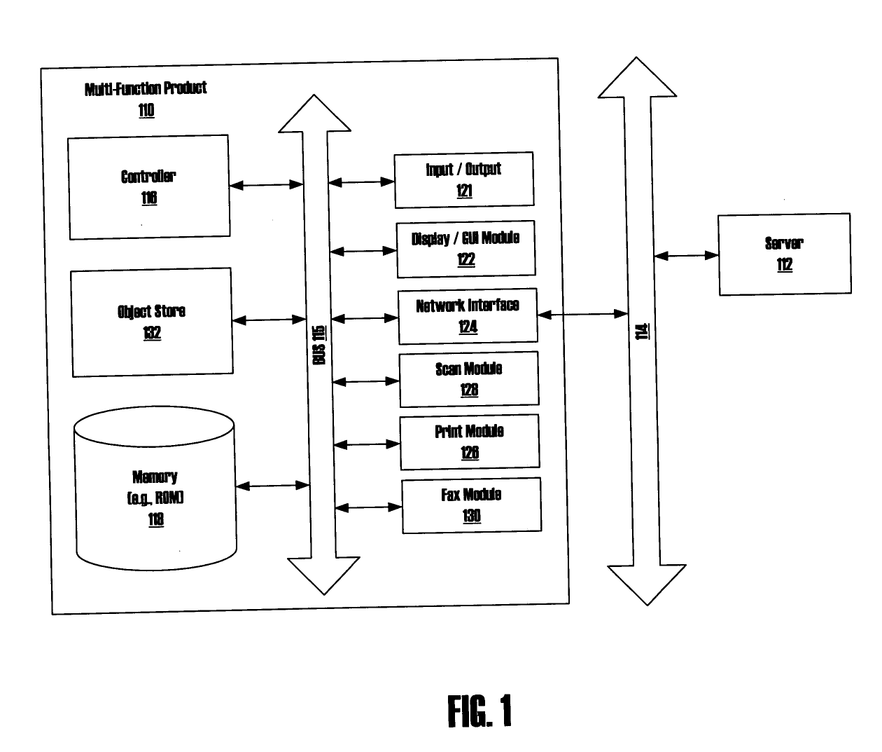

FIG. 1 shows a multi-function product (MFP) 110, according to an embodiment of the present invention. The MFP 110 may represent a multi-function device, such as a printer/scanner/fax/copier, or the control logic and/or control components within a multi-function device. The MFP 110 generally includes a controller 116, object store 132, memory 118, input/output 121, display/graphical user interface (GUI) module 122, network interface 124, print module 126, scan module 128, and fax module 130, each of which may communicate with each other via a bus 115.

The print module 126, scan module 128, and fax module 130 may implement the printing, scanning and fax functions, respectively, of the MFP 110. According to an embodiment of the invention, the print module 126 includes, for example, the necessary hardware and/or software that allow the MFP 110 to print documents, including those submitted to the MFP 110 via a network 114 and the network interface 124, and those stored local to MFP 110. Similarly, the scan module 128 may include, for example, the necessary hardware and/or software for scanning tangible documents on the MFP 110 and storing the scanned electronic documents in the memory 118, in a local attached memory device such as a flash drive, or in a remote memory on or in communication with the MFP 110 on the network 114. Likewise, the fax module 130 may include, for example, the necessary hardware and/or code for faxing electronic documents over a telephone line (not illustrated) or the like. The fax module 130 may also have an internal scanning device for scanning tangible documents or may work with the scan module 128 for scanning tangible documents and faxing documents over a telephone line.

According to an embodiment of the present invention, the print module 126, scan module 128, and fax module 130 may operate in conjunction with the controller 116, which may handle at least a portion of the processing required to effect the printing, scanning and faxing functions of the MFP 110. For instance, according to an embodiment of the invention, the scan module 128 may include a scan manager and the print module 126 may include a print engine, where the scan manager and print engine operate in conjunction with the controller 116 to handle printing and scanning processing, respectively, or the MFP 110. Similarly, the fax module 130 may include a fax engine and/or additional software and hardware for implementing fax functions, as known in the art, or may also utilize processing implemented by the controller 116 to effect fax functions.

It should be appreciated that the components described herein with respect to FIG. 1 may include computer-executable software running in conjunction with computer hardware. For instance, as illustrated in FIG. 1, and as described in detail below, the print module 126, scan module 128, fax module 130, and display/GUI module 131 may include computer executable programs (i.e., software) stored within one or more memories of the MFP 110 that are executed by the controller 116 to effect the functions described in detail herein. It will also be appreciated that the print module 126, scan module 128, and fax module 130 can include any suitable electronic and mechanical elements that together effect printing, scanning, and faxing functions, respectively, of the type that conventionally occur in commercially available multifunction machines. Such elements are well-understood by persons skilled in the art to which the invention relates. Therefore, details of the print module 126, scan module 128, and fax module 130, including the mechanical and other details of the manner in which they are constructed and communicate with one another and other elements to perform conventional printing, scanning, and faxing functions are not described in further detail herein.

The controller 116 may be a processor that executes computer executable programs with the aid of an operating system (not illustrated). According to other embodiments, one or more of the components illustrated in FIG. 1 may comprise hardware, such that the functions described herein are performed by hardware components. For instance, the controller 116, print module 126, scan module 128, fax module 130, and/or display/GUI module 122 may be implemented by an application-specific integrated circuit (ASIC), firmware, dedicated components, or the like, as are known in the art. Thus, it will be appreciated that the MFP 110 may be implemented in an entirely hardware embodiment, an embodiment combining software and hardware, or an embodiment comprised entirely of hardware. Additionally, one or more of the components illustrated in the MFP 110 of FIG. 1 may be combined to implement the methods and functions described in detail herein.

The MFP 110 is illustrated in FIG. 1 as being operatively coupled to (i.e., in communication with) the network 114, such as a LAN, WAN, or the like, via the network interface 124. The connection of the MFP 110 to the network 114 enables the MFP 110 to communicate with remote computing devices, such as one or more computers. According to an embodiment of the present invention, the MFP 110 may communicate with a server 112 via the network 114. The server 112 may be, for instance, a document server that works in concert with the MFP 110 for performing special functions on electronic documents that may be handled by the MFP 110. For example, the MFP 110 may work in concert with the server 112 for emailing electronic documents scanned by the MFP 110 to a desired electronic address accessible via the network 14. As another illustrative example, the MFP 110 may receive print requests from the server 112. Thus, the network 114 may represent a LAN that is in communication with a WAN, such as the Internet. The server 112 may also include specialized functions for setting up and controlling the operations of the MFP 110. It should also be apparent to those of ordinary skill that it is within the scope of the invention that the server 112 and MFP 110 may be combined into a single unit operatively coupled to the network 114.

The MFP 110 includes at least one memory 118 operable to store data created or received by the MFP via the network 114 and the network interface 124. The memory 118 may include ROM, RAM, optical media, or other storage, as are well known in the art. According to an embodiment of the invention, the memory 118 is operable to store containers, work flow objects, and metadata, as described in detail below. Additionally, although illustrated as separate from the object store 132, at least a portion of the memory 118, or the entire memory, maybe located within the object store 132. Thus, according to an illustrative embodiment, the object store 132 may store containers, work flow objects, metadata, and other data, local to and within the object store 132. According to one aspect of the invention, the memory 118 may also store data, such as work flow objects, uploaded to the memory 118 from a portable memory device via a portable memory interface (not illustrated) of the input/output 121. The portable memory interface may permit the MFP 110 to read/write (R/W) from a disk drive, R/W CD drive, flash media, USB device, or the like that is in communication with the MFP 110. For instance, the MFP 110 may receive a .PDF type document from a flash media inserted into the portable memory interface. According to one aspect of the invention, such a portable memory R/W device may also be a read-only device, such as read-only CD drive.

As is also shown in FIG. 1, the MFP 110 includes a display/GUI module 122 that controls the display of information on a display or GUI, which may be an input/output device of the MFP 110. The display/GUI module 122 includes numerous features described in detail herein to enable users to access, store and organize work flow objects, as is described in detail below. More specifically, the display/GUI module 122 works in conjunction with the object store 132 to enable users of the MFP 110 to retrieve, store and organize work flow objects that may be created, stored and/or transmitted to or from the MFP 110. The manipulation of such work flow objects is enabled by GUIs presented to the user via a display or GUI, and the storage and organization of such objects is handled by the object store 132 in conjunction with the controller 116. Additionally, as described in detail below, the display/GUI module 122 may operate in conjunction with the object store 132 to provide users with customized user interfaces based on the identity of a user.

According to an embodiment of the invention, a display or GUI of the MFP 110 may include an icon-based touch-screen (or similar) interface. It will be appreciated by those of ordinary skill in the art that the display or GUI may include any type of moveable-cursor-based interface, which would typically necessitate the use of a cursor-control device such as a mouse, a roller ball, or any similar cursor-control devices known by those of ordinary skill. According to one aspect of the invention, the GUI module 122 includes GUI software that operates in accordance with conventional windowing GUI paradigms.

It should be appreciated that the MFP 110 illustrated in FIG. 1 is according to an illustrative embodiment of the present invention. Therefore, one or more of the MFP 110 components described herein may be combined and/or placed external to the MFP 110, including remote from the MFP 110. Additionally, although described herein as a multi-function module, one or more of the components may be optional or unnecessary. For instance, the MFP 110 may represent a device that does not include a fax function, so that the MFP 110 may not include a fax module. Furthermore, although described herein as a MFP 110, according to an embodiment of the invention, the MFP 110 may alternatively have only a single or dedicated function, such as a scanning function requiring only the scan module 128. Other embodiments of the MFP 110 are possible. For instance, although the print module 126, scan module 128, fax module 130, and GUI module 131 are illustrated as independent components, each may be stored within one or more memories of the multi-function device 110, such as memory 118, and each may be stored in whole or part external to the MFP 110 and fetched into memory 118 on an as-needed basis. Other software elements of the types conventionally included in personal computers, such as an operating system and communications software, are also included but not shown for purposes of clarity.

### II. Work Flow Objects and Containers

According to an embodiment of the invention, the MFP 110 described with respect to FIG. 1 is operable to store and execute work flow objects and to organize workflow objects using containers. The identity of both workflow objects and containers are indexed by the object store 132 so that the object store 132 can identify and retrieve workflow objects and containers, and execute workflow objects. Both workflow objects and containers may be displayed to a user of the multi-function 110 module via icons, which may be selected by users to access the contents of containers and to execute workflow objects.

According to one aspect of the invention, work flow objects can include print jobs, confidential jobs, scan jobs, fax destinations, and other functions that may be executed by the MFP 110. It will be appreciated by those of ordinary skill in the art that workflow objects may replace traditional items, such as jobs, stored and executed by a multi-function product such as a printer/scanner/fax machine. In addition to items for execution, work flow objects may also include user profiles, settings and data associated with functions of the MFP 110. As an illustrative example, a work flow object may include a print job requested by a user via a computer communicating the print job to the MFP 110 via the network 114. As another illustrative example, a workflow object may be a stored fax number. In yet another illustrative example, a workflow object may be a user profile stored by the MFP 110.

According to an embodiment of the present invention, each work flow object shares a common format or data structure regardless of its function or use, and each contains the necessary information for its execution by the MFP 110. Thus, each workflow object includes all of the information necessary to display or identify the content, type or purpose of the workflow object, to execute the workflow object, and to manage its display and access. As will be explained in greater detail below, this allows a user to select a workflow object via the GUI, after which the workflow object is executed. For instance, each workflow object may include an icon displayable to a user via the GUI, which may be selected by the user. Upon selecting the workflow object, the appropriate function for the MFP 110 will automatically be performed. As an illustrative example, where the workflow object corresponds to a document to be printed, similar to a conventional print job, the document would be printed upon selection of the workflow object. According to another illustrative example, a workflow object may correspond to a user profile, and the user may select the workflow object to alter his or her profile.

According to an embodiment of the present invention, each workflow object may be associated with metadata that identifies characteristics of the workflow objects. As an illustrative example, the metadata may include a user associated with the workflow object, which may be used to automatically identify the workflow object after a user of the MFP 110 is authenticated. The metadata may also identify a module function to be performed, a PIN required for viewing or accessing it, an image (e.g., an icon) representing the workflow object, and the like. Metadata is associated with each workflow object, and may be stored and accessed by the object store 132, which is operable to index objects and to identify metadata associated therewith. Workflow objects may be generically stored by the MFP 110 without the need to organize workflow objects by their function, which provides the MFP 110 with flexibility in organizing, storing and providing access to such objects. Thus, multiple workflow objects corresponding to a particular user may be organized and/or presented together even though the workflow objects pertain to disparate functions of the multifunction MFP 110.

Workflow objects are organized by containers that may include one or more workflow objects. Containers, like workflow objects, may be represented by icons viewable by users of the MFP 110 via the GUI. Containers may be automatically generated upon the creation of a workflow object, or may be expressly generated by users. As an example, a container may be automatically created by the MFP 110 upon receipt of a document print request from a computer communicating with the MFP 110 via the network 114, where the container is based on the identity of the user's computer, or a user or other profile associated with the user's computer. For instance, the container may be automatically created and titled “JDoe” after a computer associated with user John Doe transmitted a print request to the MFP 110.

Containers, like workflow objects, may be associated with metadata that identifies characteristics (i.e., attributes) of each container. As an illustrative example, the metadata may include a user associated with the container, which may be used to automatically identify the container after a user of the MFP 110 is authenticated. Metadata associated with each container may be accessed by the object store 132, which is operable to index objects and to identify metadata associated therewith. Thus, referring again to the preceding example in which a container is automatically created, titled “JDoe”, and a print job (i.e., workflow object) is stored therein, a user may access that folder by walking up the MFP 110 and authenticating via the input of an ID, PIN, or the like. Upon identifying the user, the object store 132 may compare the user name to containers and workflow object, and identify that the “JDoe” container is associated with the user. As a result, the user may be presented with a GUI on which the “JDoe” container is prominently displayed. In this manner, one a user is authenticated the MFP 110 will automatically provide the user with simple access to the containers and workflow objects the user will likely access, obviating the need for the user to search for such information.

Containers may also be locally or remotely created by a user. For instance, a user may generate a container to store numerous workflow objects the user wishes to manage as a group. This may occur via a GUI of the MFP 110 or via a computer in communication with the MFP 110 via the LAN 114. According to another embodiment the invention, containers may be automatically generated in part by software and/or hardware in communication with the MFP 110, such as the Lexmark Document Solutions Suite (LDSS), a product of the assignee of the present application.

As described in detail below, one or more default containers may exist for each workflow object. For instance, when a workflow object is created at the request of a particular user, that workflow object may be automatically associated with a container corresponding to the user, which is the default container for the workflow object. However, workflow objects may also be associated with one or more containers. Thus, the same workflow object may be accessed from a plurality of containers. As an illustrative example, if a workflow object is a fax document created by a particular user, the workflow object may be included in a container associated with the user as well as a separate container that may contain all recent fax documents stored by the MFP 110. Because each workflow object is unique, each may include a unique shortcut, which may be a unique number associated with the workflow object. This permits a user to quickly identify the workflow object. According to an embodiment of the invention, the object store may index and/or store workflow objects by their unique shortcut. This also permits the object store to quickly retrieve workflow objects.

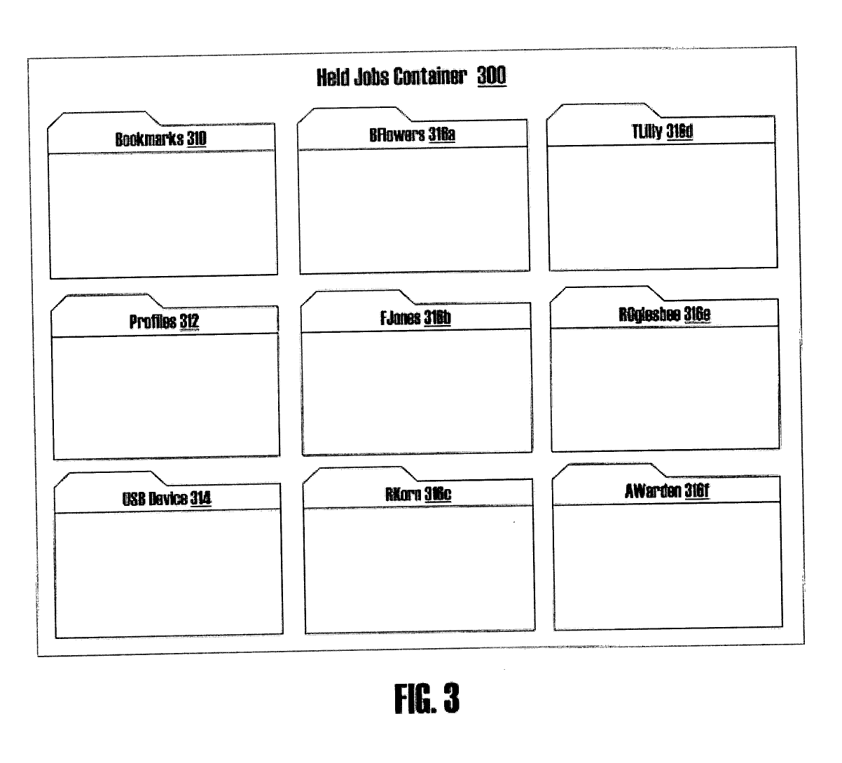

Referring once again to FIG. 1, the memory 118 is operable to store containers, work flow objects, and metadata, as instructed by the object store 132. Although illustrated as separate from the object store 132, at least a portion of the memory 118, or the entire memory, may be located within the object store 132. Thus, according to an illustrative embodiment, the object store 132 may store containers, work flow objects, metadata, and other data, local to and within the object store 132. Additionally, it will be appreciated that the display/GUI module 122 works in conjunction with the object store 132 to enable users of the MFP to create, retrieve, store and organize work flow objects and containers. Illustrative GUIs for performing such functions are described in detail with respect to FIGS. 3-18.

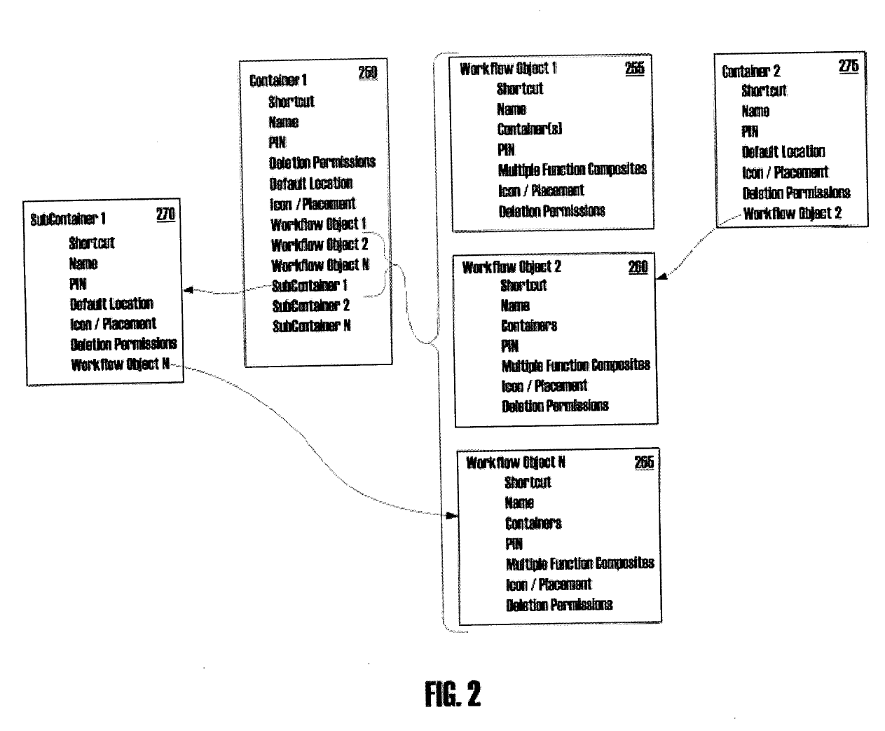

Next, FIG. 2 shows containers, workflow objects, sub-containers, and their respective characteristics or attributes, according to an illustrative example of the present invention. As described above, the object store 132 is operable to index and manage containers (including sub-containers) and workflow objects to implement the functions described herein. As such, the object store 132 is operable to search the attributes associated with each container and workflow object, and to store and manage the relationship between each. These attributes may be identified or defined by metadata corresponding to each container or workflow object and accessed by the object store 132. These functions will be readily apparent to one of ordinary skill in the art with reference to FIGS. 2-18.

As shown in FIG. 2, a container 1 250 may include a number of attributes, including a shortcut, name, PIN, deletion permissions, default location, icon and icon placement, and one or more workflow objects and/or one or more sub-containers. The container 1 250 may also have metadata (not illustrated) associated with it for defining and/or associating each of these attributes with the container 1 250. More specifically, the shortcut may be a unique number that identifies the particular container 1 250, and may be used by a user to identify the container 1 250. Additionally, the object store 132 may use the shortcut to index the container 1 250, and/or to associate attributes with the container 1 250. The container 1 250 may also include a name associated with the container 1 250. As described above, the name may be automatically generated, or alternatively may be created by a user. The container 1 250 may also include a PIN association to enable access to the container 1 250, if the container 1 250 is confidential and permits access to its contents only by authorized users. According to another aspect of the invention, the PIN association may also represent a user association, such that the container 1 250 may be accessed by those users associated with it that have rights to access the container 1 250. Similarly, a container may have deletion permissions that indicate those users that have rights to delete the container and/or change its attributes. The container 1 250 also includes an icon, illustrative examples of which are illustrated below. The icon attribute may also include placement attribute to indicate where the icon should be positioned on a GUI.

As shown in FIG. 2, workflow objects 255, 260, 265 within the container 1 250 also each include several attributes. Like the container attributes, these include a shortcut, a name, a PIN (or user association), an icon (and its location or placement), and deletion permissions. Workflow objects also include an attribute noting the one or more containers and/or sub-containers a workflow object is associated with. For instance, in the illustrative example of FIG. 2, workflow object 1 255, workflow object 2 260, and workflow object N 265 are each associated with container 1 250. However, workflow object 2 260 is also associated with container 2 275, and workflow object N is associated with sub-container 1 270. This illustrates that workflow objects may be associated with more than one container and/or sub-containers. Workflow objects also include multiple function composites, which indicate and provide the data and function of a workflow object. For instance, where a workflow object is a print job, the multiple function composites may include a copy and a fax composite, such that an icon may be provided to the user for selection that will permit the copying or faxing of the workflow objects.

Workflow objects may have one or more function composites to instruct the object store 132 and MFP 110 how a workflow object may be executed. Additionally, although the workflow objects are described above as including the data to implement a function, such as document data for printing or faxing, this data may be associated with the workflow object by metadata. Like containers, workflow attributes may be defined and/or associated with a workflow object by metadata (not illustrated), such that the object store 132 may index and identify the workflow attributes corresponding to a particular workflow object. The object store 132 may also search the container and workflow attributes. As is also shown in the illustrative example of FIG. 2, there may be one or more sub-containers associated with a container, where each includes the same attributes as a container. For instance, sub-container 1 270 includes a shortcut, name, PIN (or user association), an icon, deletion permissions, and one or more workflow objects. Although not illustrated in FIG. 2, a sub-container may also include additional sub-containers. The relationship of containers, sub-containers, and workflow objects will be further described below with reference to FIGS. 3-18.

It will be appreciated that the object store 132 may use container and workflow object attributes and metadata to associate user profiles with documents generated by each user. For instance, upon the creation of a workflow object by an authenticated or known network user, the object store may tag or otherwise associate that workflow object with the user. According to another embodiment, the object store 132 may create a user profile workflow object and associate it with other workflow objects and containers. This permits containers and/or workflow objects to be associated with a user, such that the MFP 110 can query the user profile to identify those containers and/or workflow objects associated with a user, rather than querying each workflow object and/or container to determine those associated with a user. This may permit accelerated search times when the MFP 110 or a user attempts to identify those containers or workflow objects associated with the user.

Next, FIG. 3 shows an illustrative held jobs container 300, according to an embodiment of the present invention. Note that the illustrative held jobs container 300 of FIG. 3 is intended only to illustrate the relationship between containers and workflow objects, and is not intended to represent a GUI displayed to a user of the MFP 110. As described above, the object store 132 of the MFP 110 may store containers and workflow objects in one or more memories local to or external to the object store 132. In FIG. 3, the held jobs container 300 represents the top level container stored by the object store 132, within which all other containers and all workflow objects are stored. Specifically, within the held jobs container 300 are nine (9) illustrative sub-containers 310, 312, 314, 316a-316f. FIG. 3 represents an illustrative container 300, so it will be appreciated that the sub-containers are intended to be illustrative only, and that a greater or fewer number of sub-containers may be located in the container 300. As shown in FIG. 3, the held jobs container 300 includes a bookmarks container 310, profiles container 312, a USB device container 314, and individual user containers 316a-316f. The user containers 316a-316f may be automatically named after users that have submitted workflow objects to the MFP 110. As described above, containers may include one or more sub-containers, and those one or more sub-containers may, in turn, include additional containers, etc., organized in a tree-type structure.

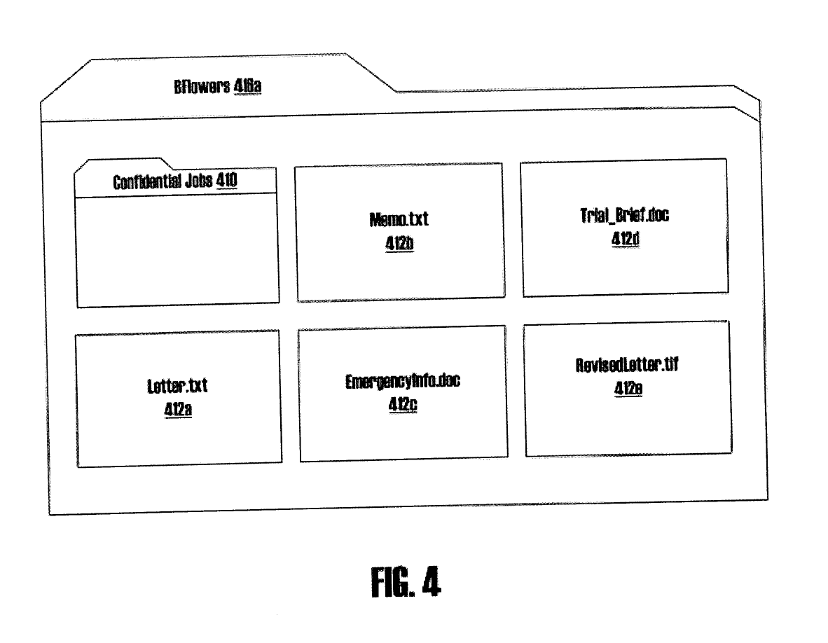

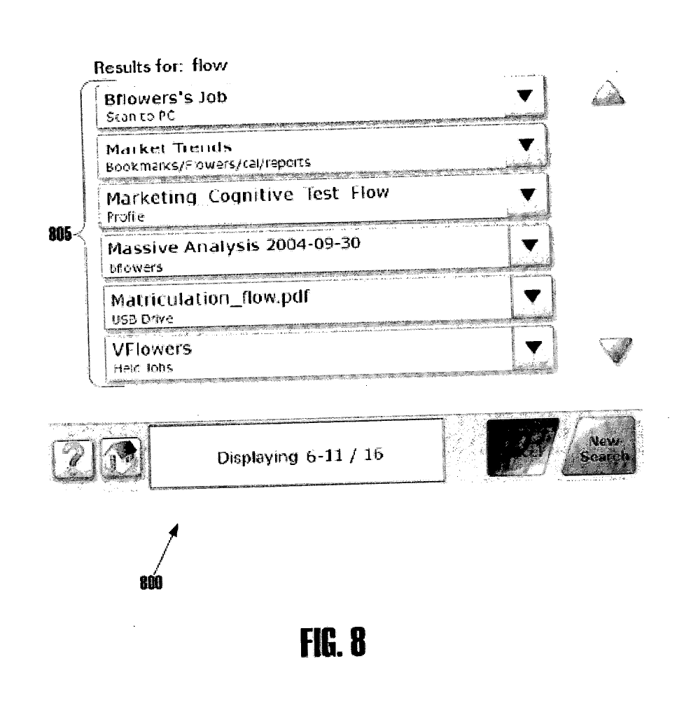

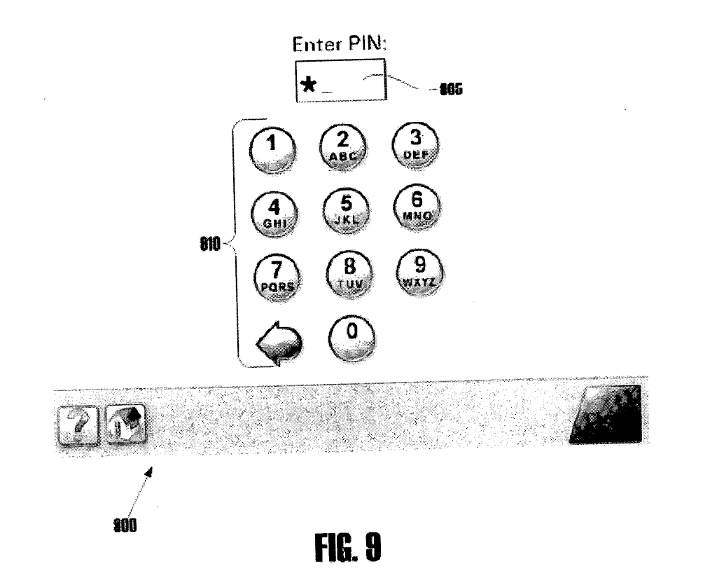

FIG. 4 shows a detailed view of a container for an illustrative user, BFlowers, which is the BFlowers container 316a of FIG. 2. As shown in FIG. 4, the BFlowers container 316a includes an additional container, confidential jobs 410, and five workflow objects 412a-412e. The confidential jobs container may include additional containers and/or workflow objects that only user BFlowers is permitted to access. As will be described below with reference to FIGS. 8 and 9, access to the confidential jobs container 410 may require a password, PIN, or the like, known only by user BFlowers. The five workflow objects shown in FIG. 4 represent documents in a variety of formats, which may be selected by a user for implementing a function of the multi-function module, such as printing copies of the objects 412a-412e. The workflow objects may have been stored within the BFlowers container 316a automatically, such as where they are received from a networked computer corresponding to user BFlowers, or input locally to the machine after user BFlowers logs into or otherwise identifies himself to the MFP 110. Alternatively, the workflow objects may be placed in the BFlowers container 316a only after an express instruction by a user.

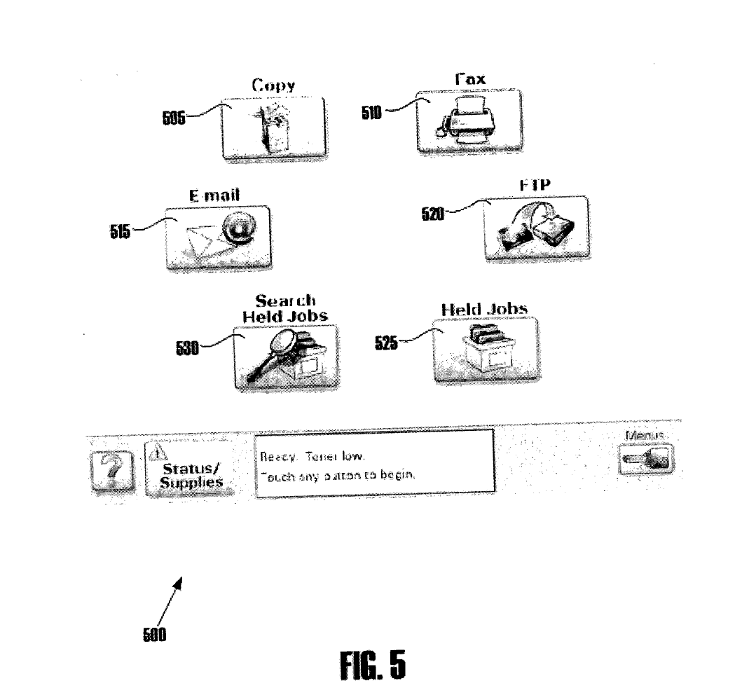

FIG. 5 shows a home screen GUI 500 that may be presented to users by the MFP 110, according to an embodiment of the invention. The home screen GUI 500 includes icons allowing a user to activate several basic functions of the MFP 110. According to one aspect of the invention, the icons may be selected by touch, where the display/GUI 122 is a touch screen display. Alternatively, the options may require the use of a cursor, one or more softkeys, or the like, as are known in the art. As shown in FIG. 5, these basic functions may include, for example, a faxing function represented by a fax icon 510, a copying function represented by a copy icon 505, a scan-to-email function represented by the email icon 515, and an FTP function represented by the FTP icon 520. Upon selecting the fax icon 510, the GUI will then provide a GUI that includes icons and associated fields for allowing the user to fax an electronic document stored by or scanned into the MFP 110 or over the network 114. Upon activating the copy icon 505, the GUI will advance to a graphical interface providing icons and fields for controlling the copying functions of the MFP 110. Similarly, upon activating the email icon 515, the GUI will provide an interface for allowing the user to type in an email message and attach electronic documents (either stored by the MFP 110, scanned by the MFP 110, stored on the server 112, or available over the network 114) to the email message, and send that email over to an electronic address over the network 114.

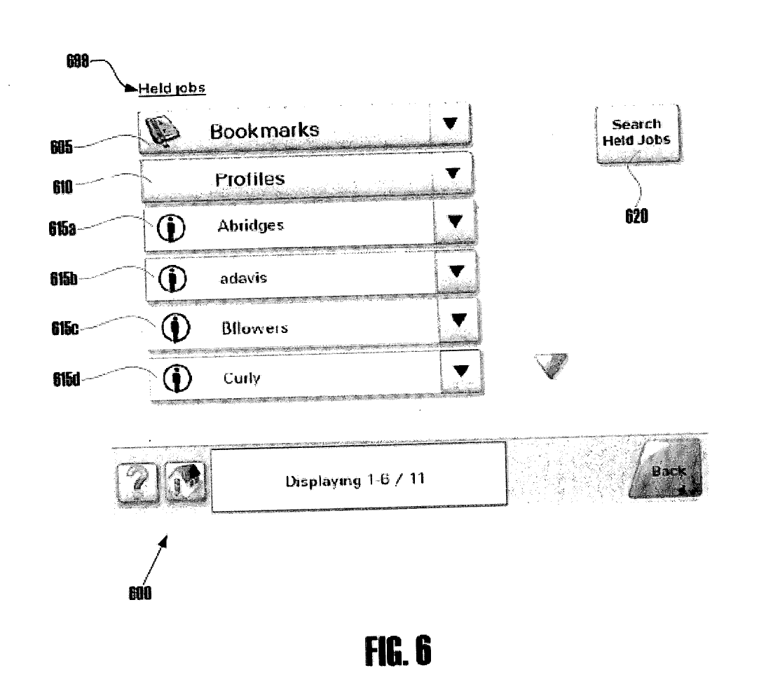

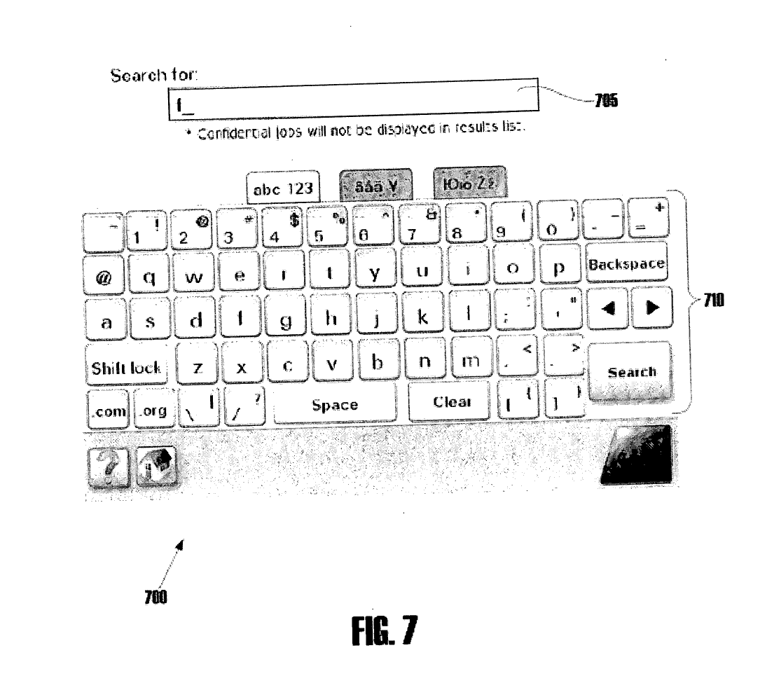

As shown in FIG. 5, the home screen GUI 500 also includes a search held jobs icon 530 and a held jobs icon 525. According to the illustrative embodiment of FIG. 5, the held jobs icon 525 represents a held jobs container, under which all workflow objects and containers are accessible. Thus, the home screen GUI 500 permits a user to access all of the containers and workflow objects managed by the object store of the MFP 110. According to an embodiment, the held jobs container may be the default container for all other containers, and the selection of the held jobs icon 525 will open a GUI showing the workflow objects and containers within it, as described below with respect to FIG. 6. According to one aspect of the invention, whenever the held jobs container includes any items, such as one or more workflow objects or containers, the search held jobs icon 530 will also be presented on the home screen GUI 500. The selection of the search held jobs icon 530 will open up a search GUI, as will be described in detail with reference to FIG. 7.

FIG. 6 shows a held jobs GUI 600, according to an illustrative embodiment of the present invention. The held jobs GUI 600 is presented to a user via the display/GUI of the MFP 110 after the user selects the held jobs icon 525 of the home screen GUI 500. The held Jobs GUI 600 includes one or more containers and/or workflow objects stored within the held jobs container. According to one aspect of the invention, for default containers and/or containers corresponding to external applications 605, 610 may be listed first, followed by icons for user-specific containers 615a-615d. As described above, the user-specific containers 615a-615d may be generated automatically based on the identity of a user's computer submitting a job to the MFP 110. According to one aspect of the invention, user-specific containers 615a-615d may be listed in alphabetical order. The user-specific containers 615a-615d may also be followed by workflow objects (not illustrated).

According to another aspect of the invention described in detail below, it will be appreciated that a user may only be presented with that user's container, as well as default containers, if the user authenticates (e.g., by entering a password, PIN, user ID, or the like) prior to viewing the held jobs GUI 600. According to one aspect of the invention, if a user has to authenticate to view the held jobs GUI 600, any workflow objects associated with the user may be placed within a container associated with the user, which may have a name matching the user's name, or matching a short form thereof. Additionally, the user's container may be placed in alphabetical order in a list of containers associated with users, where each is in alphabetical order based on a user's name. Alternatively, upon authenticating and accessing the held jobs GUI 600, a container matching the user may be listed just under the default and/or external application containers 605, 610.

More specifically, according to an illustrative example, a user may initially identify themselves to the MFP 110 via the entry of a username and password. After authentication, the MFP 110 may execute a comparison between the user's identity, such as using a unique number associated with the user, to object and/or container names used to store objects. This may be executed by examining a table of containers and/or workflow objects indexed by user, or may be accomplished by an examination of all containers and/or workflow objects to determine if they include an association with the user. If a match is made, the objects and/or containers may be prominently presented on a GUI, such as directly underneath the default containers, while the remaining items on the GUI are presented in a default or normal order. For instance, if a user submits a print job to a multi-function device, after approaching and authenticating at the device, the user may be presented with a list of held jobs, with a container for User1 listed at the top of an otherwise alphabetical list.

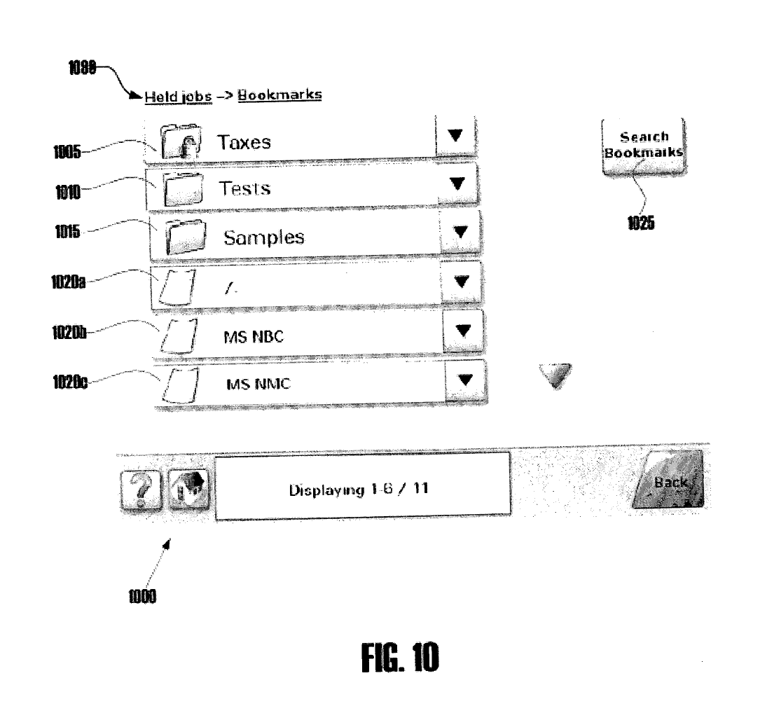

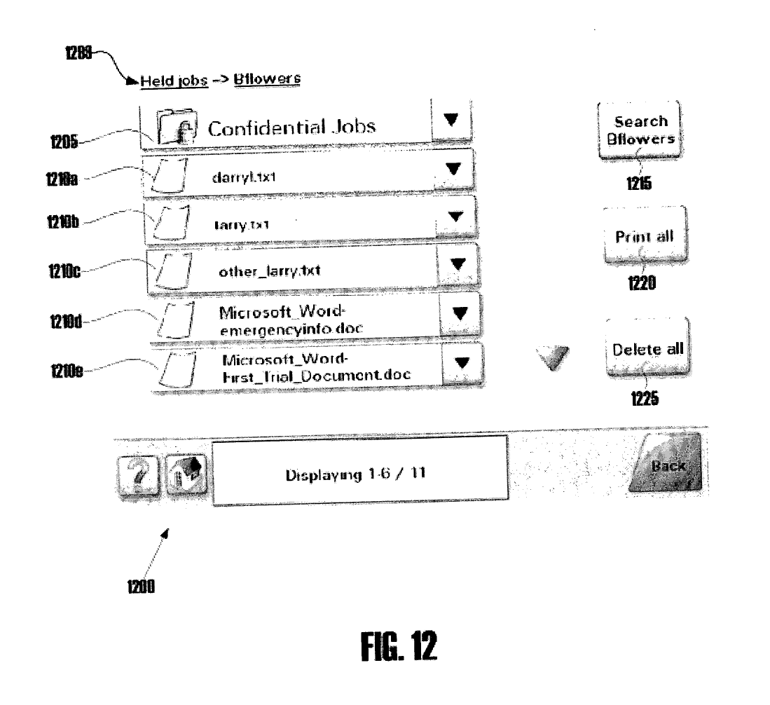

Referring again to FIG. 6, a user may select a container within the held jobs GUI 600 by selecting it, as may be accomplished via a touch screen, a mouse, or keys, as is known in the art. Selecting a container will in turn open up another GUI for that particular container, as will be illustrated below with respect to FIGS. 10 and 12. Though not illustrated in FIG. 6, according to another aspect of the invention, a user may also execute workflow objects presented by the held jobs GUI 600 by selecting the workflow object. Additionally, a user may select a search held jobs icon 620, which will direct the user to the same location as the search held jobs icon 530 of FIG. 5.

Next, FIG. 7 shows a search GUI 700, according to an illustrative embodiment of the present invention. The search GUI 700 permits a user to search through any containers and/or workflow objects within the held jobs container or sub-containers therein. To execute a search a user may enter a search term or terms in a search field 705 using a keyboard 710, which as illustrated in FIG. 7 may be similar to a conventional computer keyboard in layout to facilitate its use. Search terms may include usernames, job names, bookmark names, containers, profile names, shortcut names, and the like. The search term(s) may include any alphanumeric characters or symbols included within the illustrative keyboard 710. After inputting search term(s) by depressing or selecting a ‘search’ button, the object store 132 will retrieve containers and workflow objects matching the search term(s). The search results will be displayed to a user in a separate search results GUI 800, as shown in FIG. 8.

FIG. 8 shows a search results GUI 800, according to an illustrative embodiment of the present invention. The search results GUI 800 illustrates one or more workflow objects or containers the object store 132 identifies as matching the search term(s) input by a user via the search GUI 700. In the illustrative example shown in FIG. 8, the search term(s) are “flow”, and the search results 805 for “flow” are presented in the search results GUI 800 in alphabetical order. The search results may include containers or workflow objects, including usernames, job names, bookmark names, containers, profile names, shortcut names, and the like. In the illustrative example of FIG. 8, the search results 805 include a scan for a user having the name “Bflower's Job”, a bookmark stored within a “Flowers” container, a profile titled “Marketing_Cognitive_Test_Flow”, a document titled “Massive Analysis 2004-09-30” created by bflowers, a document on a local USB drive titled “Matriculation_flow.pdf”, and a container of held jobs for user “BFlowers”.

A user may execute any of the workflow objects presented by the search results GUI 800 by selecting the workflow object, as will be described in further detail below. Additionally, because a large number of search results may match the search term(s), the search results GUI 800 may include up and down arrows that operate in a page up/page down fashion until the last entry in the direction of travel is shown. For instance, where the search results GUI 800 may show six search results at once, if there are 16 search results to be displayed, the first screen may show the first six search results, 1-6, with a grayed-out up arrow. Pressing the down arrow may display results 6-11 (i.e., the last search result in the previous screen is repeated), while pressing the down arrow again displays results 11-16. The search results GUI 800 may also include at least button permitting a user to execute a new search, such that the selection of the button will return the user with the search GUI 700 shown in FIG. 7.

It will be appreciated that although certain containers and/or workflow objects may match the search term(s) input by a user, one or more of the containers and/or workflow objects may be confidential. According to an embodiment of the invention, confidential containers and/or workflow objects will not be displayed to users whose rights do not include the rights to access those confidential items. Thus, the display of search results on the search results GUI 800 may only be effected after the matching search results are compared against the rights of the user to view such results. According to one aspect of the invention, this comparison may be implemented by the object store 132. For instance, a user may not be able to view a confidential workflow object for a print job that was created by another user and saved as confidential, such that the creator of the work flow object may be the only person to view and execute it other than an administrator having rights to access any and all jobs and containers.

According to another embodiment of the invention, confidential containers and/or workflow objects may be displayed to all users be default regardless of the user's identity. However, to access those search results a user may be required to enter a personal identification number (PIN). Therefore, each workflow object and/or container may be associated with a permission list that includes PIN numbers against which user-input PINs may be compared to determine whether access to a workflow object or container should be granted. FIG. 9 shows an illustrative PIN GUI 900 via which a user may enter a PIN number. The PIN number may be used to identify the user and authorize the user to view a particular workflow object or container. PIN entry may be useful to identify walk-up users of the device. However, where the containers and/or workflow objects are remotely accessible by authenticated users, e.g., users on the network 114, a PIN may not be required. Referring again to FIG. 9, a user may enter a PIN using a keypad 910. The PIN may be displayed in a PIN entry window 905 as it is entered. Alternatively, the PIN entry window 905 may display asterisks in place of the PIN numbers entered by a user so as to hide the entered PIN number from onlookers. It will be appreciated to those of ordinary skill in the art that the PIN may comprise any number of numbers, and may also include letters, such that the keypad 910 may be similar to the illustrative keyboard 710 of the search GUI 700.

Referring again to the held jobs GUI 600, the held jobs container may include a bookmark container 605. According to an aspect of the invention, the bookmark container 605 may include popular, commonly accessed containers and workflow objects. Upon selecting the bookmark container 605, a bookmark GUI 1000 is provided to the user. As with any container, the bookmark container 605 can include sub-containers as well as workflow objects that, when selected, initiate an action, such as printing a page. The workflow objects within the bookmark container may be referred to as bookmarks. In the illustrative example of FIG. 10, the bookmark GUI 1000 includes three containers 1005, 1010, 1015 and at least three workflow objects (or bookmarks) 1020a, 1020b, 1020c. The bookmark GUI 1000 may also include at least button permitting a user to execute a search of the bookmarks 1025, which may direct the user to the search GUI 700 shown in FIG. 7, which may then be used to search only containers and workflow objects within the bookmark container 605.

As with any screen listing containers and workflow objects, containers may be displayed first, followed by workflow objects. As also illustrated in the bookmark GUI 1000, confidential items, such as the confidential container “Taxes” 1005, may be illustrated with an icon representing a folder and a lock. Containers 1010, 1015 that are not confidential may be illustrated with an icon representing a folder. Both containers and workflow objects may be represented based on their type. For instance, where workflow objects represent documents that may be printed, they may be represented by an icon representing a piece of paper. As another example, where a container is associated with a particular user profile, it may be represented by an icon representing a person, such as the icons for user-specific containers 615a-615d in the held jobs GUI 600 described above.

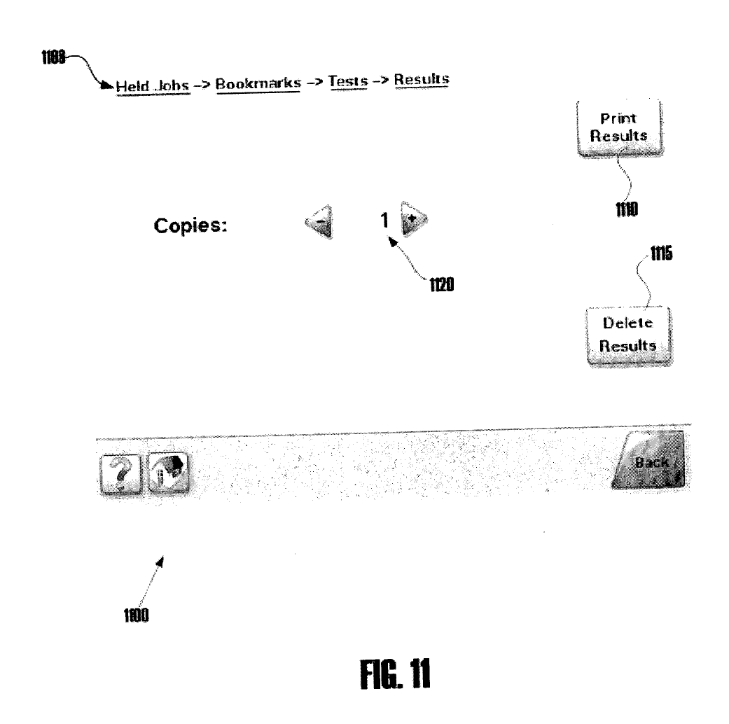

When a user selects a container or workflow object from the bookmark GUI 1000, the MFP 110 may display the contents of the container or execute the bookmark. As an illustrative example, a “Results” workflow object may represent a document. The “Results” workflow object may have been accessed via a selection of the “Tests” container 1010, within which it was presented as a workflow object. According to an embodiment of the invention, bookmarks may be printed or deleted. Thus, upon its selection by the user, the MFP 110 will execute the workflow object and the user may be presented with the print/delete GUI 1100 shown in FIG. 1. The print/delete GUI 1100 includes a print icon 1110 and a delete icon 1115, which allows the user to print or delete the workflow object. As illustrated, each of the icons 1110, 1115 may include the name of the workflow object “results”. A user is also presented with a copy count 1120 that may be increased or decreased using one or more keys, such as the “+” and “−” icons shown in FIG. 11. When the user wishes to print the desired number of copies, the user will select the print icon 1110 and the MFP 110 will print the number of copies indicated by the copy count. Alternatively, selecting the delete icon 1115 will result in the complete deletion of the “results” workflow object. Thus it may no longer be accessed from any containers, including the bookmark container 605, and the “tests” container 1010.

Next, FIG. 12 shows an illustrative user-container GUI 1200, according to an illustrative embodiment of the invention. The user-container GUI 1200 may have been accessed, e.g., via a selection of a user container from the GUI 600 shown in FIG. 6. According to another embodiment of the present invention, upon authenticating at the MFP 110, a user may be automatically presented with their user-container via the user-container GUI 1200. In particular, the user-container GUI 1200 illustrated in FIG. 12 is the user-specific container 615c corresponding to user “Bflowers”. The user-specific container GUI 1200 is similar in layout to other GUIs illustrating containers and/or workflow objects. As shown in FIG. 12, a user may use the user-specific GUI 1200 to access a sub-container 1205 or one or more workflow objects 1210a-1210e. The user-container GUI 1200 may also include at least one button permitting a user to execute a search of the user-specific container 615c, which may direct the user to the search GUI 700 shown in FIG. 7, which may then be used to search only containers and workflow objects within the user-specific container 615c.

As shown in FIG. 12, whenever two or more non-confidential workflow objects, e.g. print jobs, are present at the level of a container displayed via a GUI, that GUI may provide a “Print all” icon and a “Delete all” icon. Thus, as shown in the user-specific container GUI 1200, a “Print all” icon 1220 and a “Delete all” icon 1225 are provided to permit the printing and/or deletion of all of the workflow objects within the user-specific container 615c. According to another aspect of the invention, the “Print all” icon 1220 and “Delete all” icon 1225 also permit the printing and/or deletion of all of workflow objects within sub-containers of the user-specific container 615c. However, the print all and delete all functions may not include any confidential workflow objects stored within a confidential folder within the container. According to one aspect of the invention, whenever one or more workflow objects within a container, such as the user-specific container 615c represented by the user-container GUI 1200, are confidential, a “confidential jobs” icon 1205 representing a confidential folder within the container becomes the first selection in the container and workflow object list. Non-confidential jobs are listed as the next selections. Thus, to print or delete confidential workflow objects requires a user to first select the confidential jobs icon 1205, and may require the input of a PIN or similar password, as described above with respect to FIG. 9.

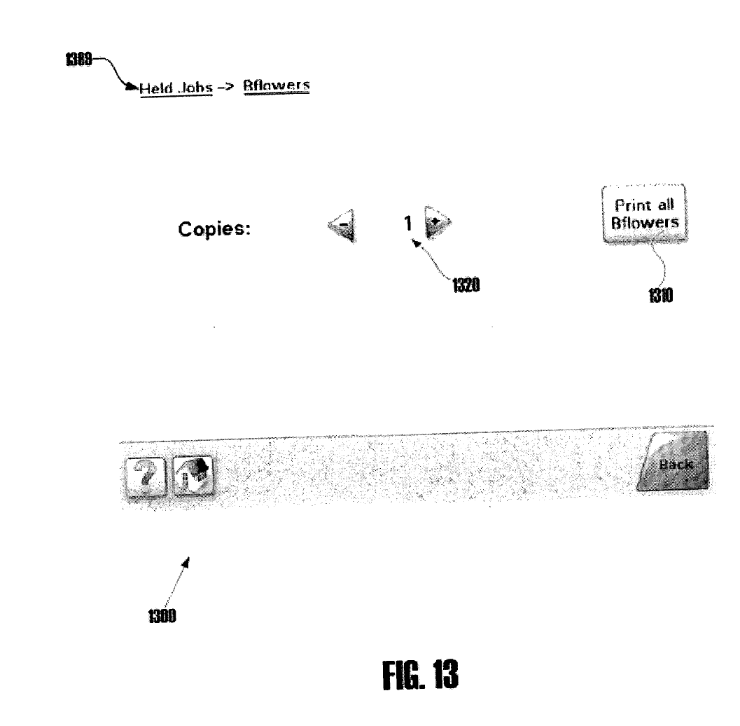

If a user selects the print all icon 1220, a Print All GUI 1300 is presented to the user, as is shown in the GUI 1300 of FIG. 13, according to an embodiment of the present invention. The Print All GUI is similar to the print/delete GUI 1100 for a single work flow object, except that a print all button 1310 includes the container name instead of a workflow object name, and the number of copies 1320 adjustable by a user is applied to all of the workflow objects printed from the container. Additionally, because a delete all button exists at the higher level, it does not appear in the print all GUI 1300.

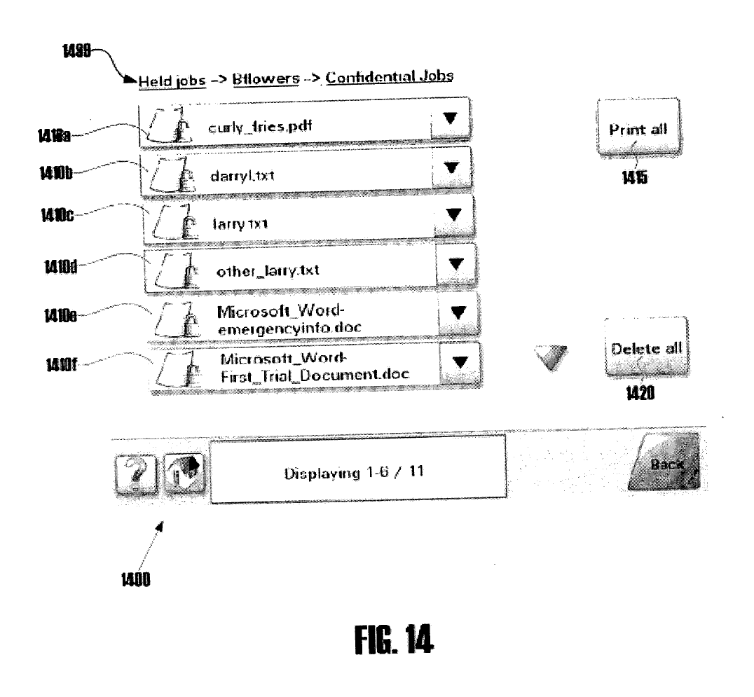

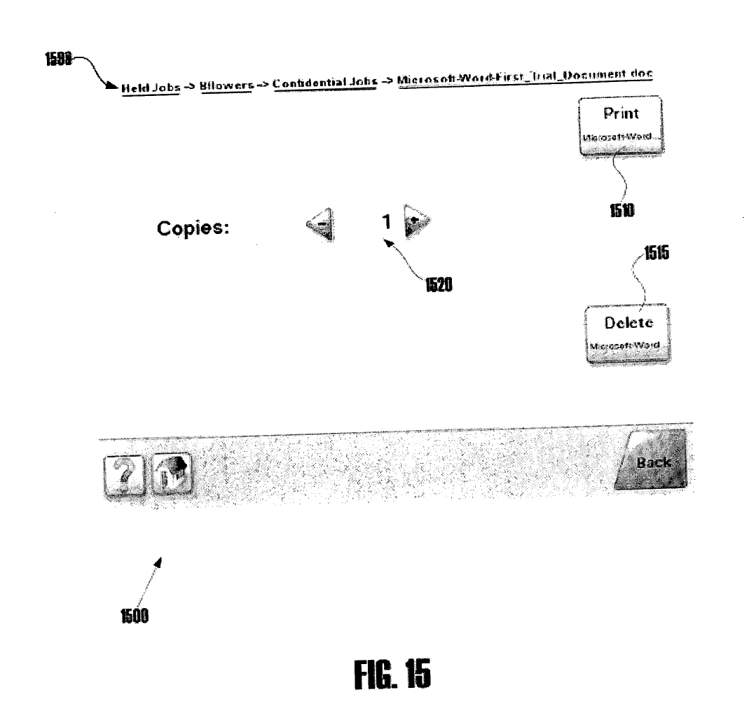

Continuing with the illustrative user-container GUI 1200 shown in FIG. 12, if the confidential jobs container 1205 is selected, a user-specific confidential jobs GUI 1400 will be presented to the user after the user enters a PIN or similar password, as described with respect to FIG. 9. The user-specific confidential jobs GUI 1400 may display each of the workflow objects and/or confidential folders of the user, including workflow objects 1410a-1410f in illustrative example of FIG. 14. Those workflow objects 1410a-1410f in the user's confidential container can be selected for individual printing. For instance, as shown in the Workflow Object Print GUI 1500 shown in FIG. 15, upon the selection of a workflow object from the user-specific confidential jobs GUI 1400, the user can delete the workflow object via selection of the delete icon 1515, or print the workflow object via the print icon 1510. The user is also presented with a copy count 1520 that may be increased or decreased using one or more keys, such as the “+” and “−” icons shown in FIG. 11. When the user wishes to print the desired number of copies, the user will select the print icon 1510 and the MFP 110 will print the number of copies indicated by the copy count.

Navigating through each of the above-described GUIs may be achieved using ‘back’ buttons on the GUIs, and/or using the directory links at the top of each GUI. Thus, each of the underlined directory links 699, 1099, 1199, 1299, 1499, 1599 will permit a user to navigate to the GUI representing the location identified by the directory link, similar to an HTML link on a web page. Further, each of the GUIs of the present invention may include such directory links. As an illustrative example, selecting on the ‘Held Jobs’ portion of the directory link 1199 in the print/delete GUI 1100 will navigate the user to the held jobs GUI 600, while selecting the ‘Bookmarks’ portion of the directory link 1199 in the in the print/delete GUI 1100 will navigate the user to the bookmark GUI 1000.

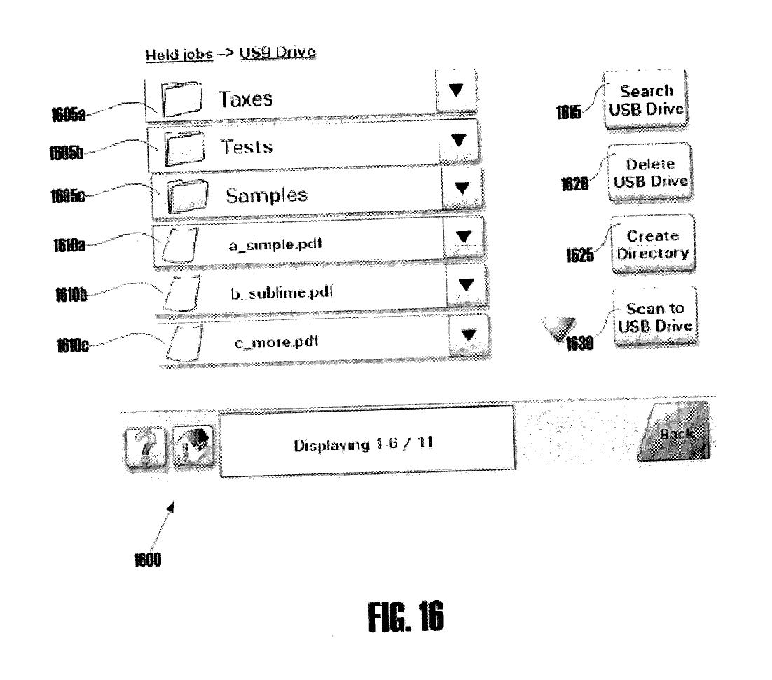

The MFP 110 of the present invention may also present the user with GUIs for illustrating those containers and/or workflow objects stored external to the MFP 110. For instance, as shown in FIG. 16, the MFP 110 may display a USB Drive GUI 1600 for displaying the containers and workflow objects stored within a storage device, such as a flash drive, connected to the MFP 110 via a USB. Thus, upon attaching a USB device to the MFP 110, the controller 116 may identify the device. Upon requesting the USB Drive GUI 1600 the object store will read the contents of the USB device and display the contents via the USB Drive GUI 1600. In the illustrative example of FIG. 16, the USB Drive GUI 1600 includes three containers 1605a-1605c and at least three workflow objects 1610a-1610c. Similar to the bookmark GUI 1000, the USB Drive GUI 1600 may also include at least one search button 1615 permitting a user to execute a search of the USB Drive containers and workflow objects, which may direct the user to the search GUI 700 shown in FIG. 7, which may then be used to search only containers and workflow objects within the USB drive.

The USB Drive GUI 1600 also includes a delete icon 1620 permitting a user to delete all contents of the USB device. Although not illustrated, upon selecting a delete function via the selection of the delete icon 1620, a user may be requested to confirm deletion. As shown in FIG. 16, a user may also create a new directory via the selection of the create directory icon 1625. This may permit the creation of a container stored local to the MFP 110 and managed by the object store to which the USB contents may be copied. According to another aspect of the present invention, this may include the creation of a directory, or container, local to the USB drive. As shown in FIG. 16, the user may also scan to the USB drive via selection of the scan icon 1630. This permits, for instance, the storage on the USB device of a scanned image of a document scanned by the MFP 110.

Selecting a “Scan to [x]” button will scan and image and store it in the [x] directory. Default values for the settings may be factory default values for scan parameters, and the default file name for a scan may be “Scanned-image”. However, if an image with the same name exists in the directory, a dash followed by a number may be appended to the end of the name. Thus Scanned-image.pdf may be the default for the first scan. If tried again, it would become Scanned-image-1.pdf, and then the third try it would be Scanned-image-2.pdf.

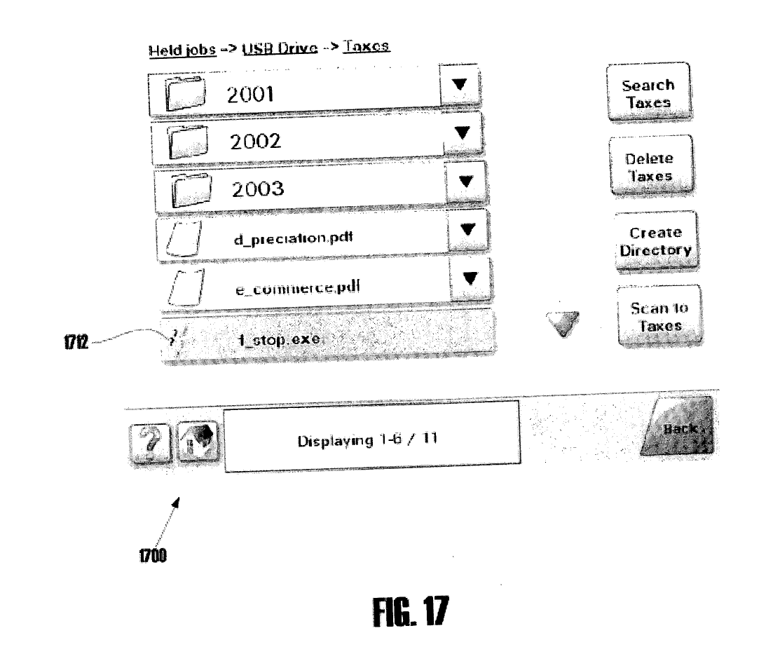

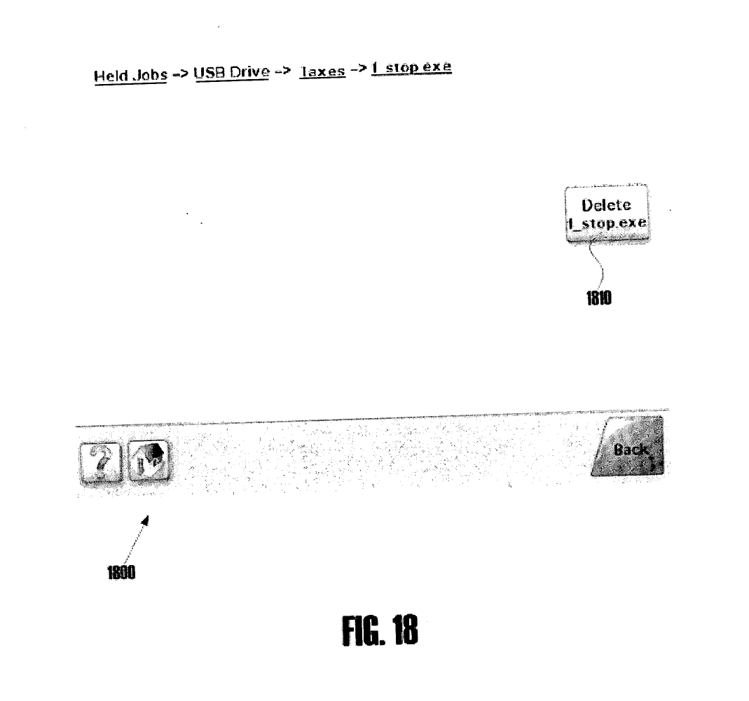

As shown in the illustrative USB Drive Subdirectory GUI 1700 of FIG. 17, a file 1712 within the USB device may have an extension that is not recognized by the MFP 110. According to one aspect of the invention, the file is illustrated in the GUI 1700 but may not be selected by a user. According to an alternative aspect of the invention, the file may not be displayed by the GUI 1700. According to yet another aspect of the invention, the file may be displayed and selected, wherein the selection of the file permits the deletion of the file via the selection of a deletion icon 1810 on a file deletion GUI 1800, as shown in FIG. 18.

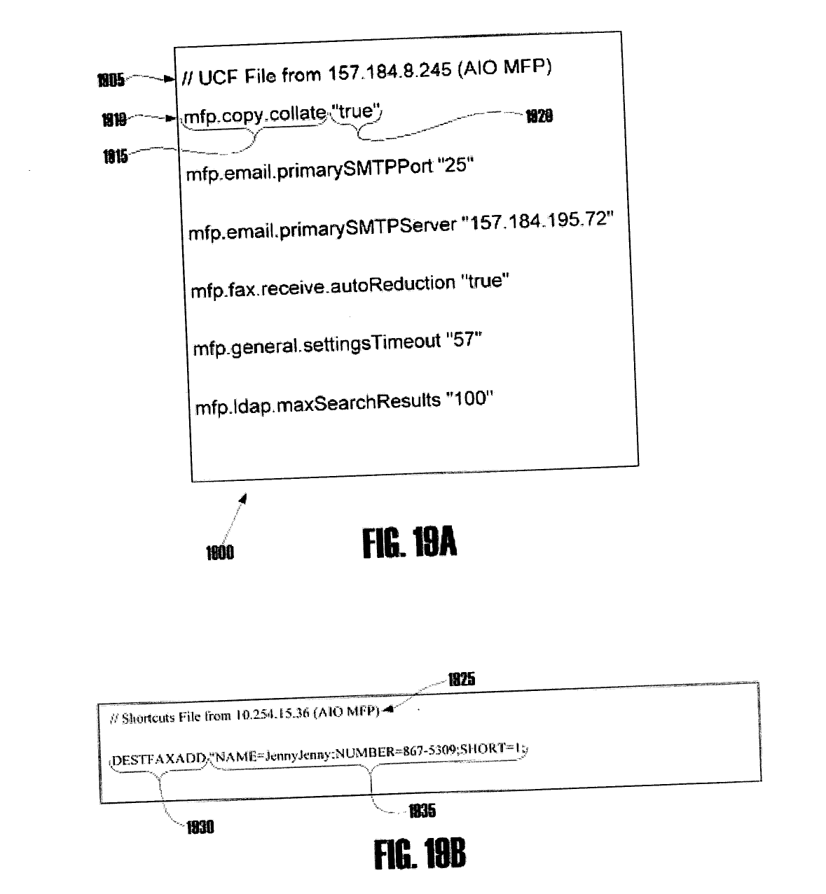

As will next be described with reference to FIGS. 19A and 19B, to effect the execution of workflow objects the MFP 110 uses device settings that may be defined and stored local to the MFP 110, or external to the device, such as on a remote server. Specifically, FIG. 19A shows an illustrative universal configuration file (UCF) 1900 that permits the designation and subsequent automatic establishment of MFP 110 settings in a single step rather that requiring a user to change each individual item, for instance, each time the user wishes to execute a function of the MFP 110. Among other device settings known to those of ordinary skill in the art, the UCF 1900 can define settings including paper size, paper source, darkness, orientation, fax name, enlargement, reduction, number of copies, fax number destination, ftp destination, output format, email address, and the like. In particular, the UCF 1900 is used to establish MFP settings for the execution of a workflow object by the MFP 110. The UCF 1900 may be used to automatically effect the change of multiple MFP settings, either automatically or upon a user's request.

According to one aspect of the invention, the MFP 110 will use one or more default, pre-established UCFs to execute workflow objects for each MFP 110 function until a user makes changes to the MFP 110 settings and/or until the one or more default UCFs are altered. The default UCFs may be stored local to the MFP 110 and updated by a server, user, or the like. According to another aspect of the invention, the default UCFs may be stored external to the MFP 110. To apply the settings established by the UCFs, the object store 132 interprets the UCFs to execute workflow objects of the MFP 110. Because the object store 132 is operable to interpret all of the values that are within a UCF, a job specific UCF may be created that changes user settings, rather than default settings. Thus, a default UCF may be used to execute workflow objects for a first user, while a job-specific UCF may be used to execute workflow objects for a second user.

According to one aspect of the invention, a UCF may be associated with any workflow object. Thus, each time the workflow object is executed the MFP 110 may utilize the UCF to establish MFP settings for executing the workflow object. A UCF may be established for a class of workflow objects, for instance, all work flow objects associated with a particular user, or all workflow objects that are both associated with a particular user and that execute a particular function of the MFP 110. A UCF may also be established for an individual workflow object regardless of the user instructing the MFP 110 to execute the workflow object. It will further be appreciated that the use of a UCF to establish MFP settings also permits the establishment of settings for any and all networked MFPs in a system. Therefore the settings for a workflow object in a system may be effected regardless of the specific MFP the user wishes to use to execute the workflow object.

Although non-default UCFs may be pre-stored and/or accessed by a user via a shortcut, a UCF may also be automatically generated and/or updated by a user the first time a user executes a function of the MFP 110. For instance, a UCF may be automatically created for a user executing a particular function of the MFP 110 with altered (i.e., non-default) settings. It will be appreciated that this does not require that the MFP 110 execute the workflow object, as device settings may be automatically stored after their setting by the user but prior to the execution of the workflow object by the MFP 110. As an illustrative and non-limiting example, a particular set of copy settings may be required for copying a passport, settings that may include scale, darkness and content type. A UCF for applying those settings may be written and stored in the MFP 110 or created by a user so that they may be automatically applied any subsequent times the user (or other users) wish to effect the copying of a passport. For instance, a shortcut name may be applied to the passport copy function, which is associated via metadata with the UCF such that the next time a user wishes to copy a passport the user can enter a shortcut number into the MFP 110, after which the UCF is read and the appropriate MFP 110 function is opened with the settings applied as if the user entered them at the MFP 110 via a GUI. According to one aspect of the invention, the user may be presented with a “save settings” icon or the like, which permits the user to save the UCF associated with a workflow object.

According to an aspect of the invention, the UCF may be in an 8-bit Unicode Transformation Format (UTF-8), as is known in the art. It will be appreciated that although FIG. 19A illustrates a UCF 1900 in UTF-8 format, other formats may be implemented to effect the functions described herein. Referring to the illustrative UCF 1900 shown in FIG. 19A, the UCF 1900 can be divided into multiple lines that can include comments 1905 designated by the symbols ‘//’ positioned at the start of a line. In the illustrative example, all other lines of the UCF 1900 designate device settings to be set by the MFP 110 for executing an object. As shown, each device setting line begins with a name string 1915, which is the name of the setting for the MFP 110. The text that follows the names is the setting value 1920, which in the embodiment of FIG. 19A is placed in quotation marks. For instance, the setting for the darkness of a copy may be: mfp.copy.darkness “5”, which sets the copy darkness to the 5 setting, which is within the range of darkness settings for the MFP 110. According to one aspect of the invention, the name string combined with the setting value may be referred to as set of value pairs.

The object store 132 processes the UCF by applying the setting values 1920 for each setting identified by the name string 1915. The UCF may include any number and/or combination of settings and setting values to be used to effect the execution of a workflow object. According to an aspect of the invention, if the setting (i.e., name string) and/or setting value are invalid the instruction is ignored and default values for the setting and setting value are used. It will be appreciated by those of ordinary skill in the art that the UCF 1900 may be used to not only set MFP 110 functions typically accessed by users of the MFP 110 via GUIs, but also general settings of the MFP 110 that are normally controlled by an administrator. For instance, the UCF may include a name string and setting values that instructs the object store 132 to alter settings such as the number of search results to display to one or more users. As another example, the UCF may be used to instruct the MFP 110 and object store as to the new identity and location of a server on the network 114.

As shown in FIG. 19B, shortcuts for destinations may also be defined by a UCF. These may be used to identify email destinations, ftp destinations, and fax destinations. According to an aspect of the invention, the shortcuts may be associated with their respective destinations such that the UCF shortcuts define the settings to be used by the MFP 110 each time the destination is used. As shown in FIG. 19B the UCF may include a comment line 1925 similar to that described above with respect to FIG. 19A. The UCF includes a shortcut key 1930 similar to that of the name string described above, where the shortcut key 1930 identifies the type of function the shortcut key is applicable to. The text that follows the shortcut key 1930 by a space, is the setting value 1935, which is placed in quotation marks. For instance, the setting for the shortcut key and setting value 1935 for a fax destination may be: DESTFAXADD “NAME=JennyJenny;NUMBER=555-5309;SHORT=1”, which sets the name of the fax recipient to JennyJenny, the fax recipient's number to 555-5307, and the shortcut for accessing the setting to “1”. According to one aspect of the invention, the shortcut key 1930 and setting value 1935 may be referred to as set of value pairs. Further, as with the UCF described with respect to FIG. 19A, above, if the shortcut key 1930 and/or setting value 1935 are invalid the instruction is ignored.

According to another aspect of the invention, a UCF itself may be a workflow object, such that it may be assigned a shortcut name. Therefore, upon execution of the UCF workflow object the MFP settings may be automatically changed according to the UCF. Thus, a user can implement particular settings for one or more workflow objects by simply typing in a shortcut key for a UCF that instruct the MFP to execute objects using one or more desired device settings. Additionally, although a UCF may be associated with a particular workflow object, a UCF may also be associated with a particular user based on the user's identity where the user has identified themselves to the MFP 110, for instance, through the use of a PIN, username, and/or password. The MFP 110 will then execute workflow objects using the UCF associated with the user.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for implementing multi-function device settings, comprising:
storing at least one workflow object, wherein the at least one workflow object is associated with at least one function of a multi-function device, and at least one device setting;
receiving, at the multi-function device, a request to execute the at least one workflow object; and
executing the at least one workflow object using the at least one device setting.

2. The method of claim 1, further comprising storing a plurality of default device settings, and wherein the at least one device setting is different than each of the plurality of default device settings.

3. The method of claim 1, wherein the at least one device setting comprises a value pair.

4. The method of claim 3, wherein the value pair comprises a name string and a setting value.

5. The method of claim 3, wherein the value pair comprises a shortcut key and a setting value.

6. The method of claim 1, wherein the at least one device setting is defined by a universal configuration file.

7. The method of claim 1, wherein the at least one device setting is associated with a user.

8. The method of claim 1, wherein the at least one device setting is created by a user and associated with a plurality of workflow objects.

9. A method of changing multi-function device settings, comprising:
receiving a request to execute at least one job;
identifying that the at least one job is associated with the at least one device setting, wherein the at least one device setting is stored in a configuration file;
automatically changing the settings of a multi-function device to the at least one device setting; and
executing the at least one job using the at least one device setting.

10. The method of claim 9, further comprising storing the at least one device setting in a configuration file.

11. The method of claim 9, wherein receiving a request to execute at least one job comprises receiving a shortcut name, wherein the shortcut name identifies the at least one job.

12. The method of claim 9, wherein the at least one device setting is selected from the group of settings consisting of an email destination, a fax destination, and an ftp destination.

13. The method of claim 9, wherein the at least one device setting comprises a value pair.

14. The method of claim 13, wherein the value pair comprises a name string and a setting value.

15. The method of claim 13, wherein the value pair comprises a shortcut key and a setting value.

16. A device operable to print a document, comprising:
at least one interface, wherein the at least one interface is operable to receive a configuration file associated with a workflow object; and
an object store operable to receive the configuration file, and in response, operable to:
use the configuration file to identify one or more device settings; and
automatically alter the settings of a multi-function product for executing the workflow object.

17. The device of claim 16, wherein the configuration file is automatically generated by the multi-function product in response to a user previously altering the one or more device settings.

18. The device of claim 16, wherein the configuration file comprises a value pair.

19. The device of claim 18, wherein the value pair comprises a name string and a setting value.

20. The device of claim 18, wherein the value pair comprises a shortcut key and a setting value.
